(19) United States
(12) Patent Application Publication
(10) Pub. No.: US 2014/0013198 A1
(43) Pub. Date: Jan. 9, 2014

(54) REFERENCE MANAGEMENT IN EXTENSIBLE MARKUP LANGUAGE DOCUMENTS

(71) Applicant: Steffen Richard FREDERIKSEN, Skanderborg (DK)

(72) Inventor: Steffen Richard FREDERIKSEN, Skanderborg (DK)

(73) Assignee: DITA EXCHANGE, INC., Campbell, CA (US)

(21) Appl. No.: 13/543,153

(22) Filed: Jul. 6, 2012

(51) Int. Cl. G06F 17/00

(52) U.S. Cl. 715/208; 715/255; 715/241; 715/205

(57) ABSTRACT

A method includes defining one or more property fields within a document of a collection of one or more documents, where the one or more property fields store reference information. The method further includes performing an operation on the document. The method further includes extracting reference information associated with one or more references within the document. The method further includes populating the one or more property fields with the reference information associated with the one or more references within the document. The method further includes creating an index of the reference information populated within the one or more property fields.

### BACKGROUND

1. Field

Certain embodiments of the invention relate generally to computer systems, and, more particularly, to computer systems that are configured to manage documents.

2. Description of the Related Art

Generally, in a large collection of electronic documents (i.e., documents), such as Office Open extensible markup language (XML) Microsoft Word® documents, at least one reference document can reference (or link to) at least one source document. Such referencing can be effectuated, for example, by creating a hyperlink within the reference document, using a word processor, such as Microsoft Word®. By referencing (e.g., linking to) a source document, the reference document can reference (e.g., link to) content contained within the source document. Thus, when managing such a collection of documents, it can be vital to know whether a source document (and thus, the content contained within the source document) is referenced by one or more reference documents. However, keeping track of the references (i.e., what is referenced where), and managing the references (if a reference target changes its name or its location) can be a significant challenge.

For example, a document author (such as a pharmaceutical company) may have a large collection of documents (such as a collection of documents associated with a request for approval of a drug from the Food and Drug Administration), where the collection of documents includes documents A, B, C, and D. In document D, the author can create content (such as a table) that the author desires to reuse in documents A, B, and C. Thus, the author can create a reference (e.g., link) between documents A and D, documents B and D, and document C and D. However, the author generally has to maintain information indicating that documents A, B, and C are each linked to document D, in case the author would like to edit any of the documents in the future. Similarly, the author generally has to maintain name/location information associated with document D, in case the name or the location of document D changes. Such maintenance can be unduly burdensome.

A traditional approach to manage this type of information is to register each reference, when created by a user or administrator of a document, in a database, and then use the database to keep track of the reference information. For example, a word processor, such as Microsoft Word®, can include an authoring tool that allows the word processor to update a database every time a reference is created within a document that is part of a collection of documents, where the database includes one or more records that keep track of one or more references within the collection of documents. However, this approach has two major disadvantages. First, it involves adding special functions and features to the word processor to register references in the database when the references are created, and to change or delete the registered references in the database when the references are changed or deleted. Thus, this approach will only work if the word processor includes these special functions and features. Second, the approach involves creating a specialized database, including an application programming interface (API) call to query the database. Such requirements can also be unduly burdensome.

### SUMMARY

According to an embodiment of the invention, a method includes defining one or more property fields within a document of a collection of one or more documents, where the one or more property fields store reference information. The method further includes performing an operation on the document. The method further includes extracting reference information associated with one or more references within the document, where the one or more references reference content located outside of the document. The method further includes populating the one or more property fields with the reference information associated with the one or more references within the document. The method further includes creating an index of the reference information populated within the one or more property fields, where the index is associated with the collection of one or more documents.

According to another embodiment, an apparatus includes a memory configured to store one or more modules. The apparatus further includes a processor configured to execute one or more modules stored within the memory. The apparatus further includes a property field definition module configured to define one or more property fields within a document of a collection of one or more documents, where the one or more property fields store reference information. The apparatus further includes an operation module configured to perform an operation on the document. The apparatus further includes a reference information extraction module configured to extract reference information associated with one or more references within the document, where the one or more references reference content located outside of the document. The apparatus further includes a property field population module configured to populate the one or more property fields with the reference information associated with the one or more references within the document. The apparatus further includes a reference information index module configured to create an index of the reference information populated within the one or more property fields, where the index is associated with the collection of one or more documents.

According to another embodiment, a non-transitory computer-readable medium, including a computer program embodied therein, is configured to control a processor to implement a method. The method includes defining one or more property fields within a document of a collection of one or more documents, where the one or more property fields store reference information. The method further includes performing an operation on the document. The method further includes extracting reference information associated with one or more references within the document, where the one or more references reference content located outside of the document. The method further includes populating the one or more property fields with the reference information associated with the one or more references within the document. The method further includes creating an index of the reference information populated within the one or more property fields, where the index is associated with the collection of one or more documents.

### BRIEF DESCRIPTION OF THE DRAWINGS

Further embodiments, details, advantages, and modifications of the present invention will become apparent from the following detailed description of the preferred embodiments, which is to be taken in conjunction with the accompanying drawings, wherein:

FIG. 1 illustrates a block diagram of an apparatus, according to an embodiment of the invention.

FIG. 2 illustrates a process of creating one or more property fields for a referencing document, where the referencing document includes a reference to a referenced document, according to an embodiment of the invention.

FIG. 3 illustrates a process of creating one or more property fields for a document, where the document is created or updated, according to an embodiment of the invention.

FIG. 4 illustrates a method, according to an embodiment of the invention.

### DETAILED DESCRIPTION

It will be readily understood that the components of the present invention, as generally described and illustrated in the figures herein, may be arranged and designed in a wide variety of different configurations. Thus, the following detailed description of the embodiments of a method, apparatus, system, and computer-readable medium, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “an embodiment,” “one embodiment,” “another embodiment,” “an alternative embodiment,” “an alternate embodiment,” “certain embodiments,” “some embodiments,” “different embodiments” or other similar language, throughout this specification refers to the fact that a particular feature, structure, or characteristic described in connection with the embodiment may be included in at least one embodiment of the present invention. Thus, appearances of the phrases “an embodiment,” “one embodiment,” “another embodiment,” “an alternative embodiment,” “an alternate embodiment,” “in certain embodiments,” “in some embodiments,” “in other embodiments,” “in different embodiments,” or other similar language, throughout this specification do not necessarily all refer to the same group of embodiments, and the described features, structures, or characteristics may be combined in any suitable manner in one or more embodiments.

According to one embodiment, when a document is stored or updated in a server, the document can be analyzed, and reference information associated with one or more outbound references (e.g., links) of the document can be extracted. The extracted reference information can be stored within one or more property fields that are defined within the document. This can be done for each document of a collection of documents, so that each document includes one or more property fields containing reference information. The one or more property fields contained within the collection of documents can then be indexed so that the reference information is included within an index that can be stored on the server. The index can then be used to create one or more queries that can be used to obtain reference information associated with the collection of documents, such as identifying all documents with a reference (e.g., link) to a specific document.

In the following description, the following terms are used as synonyms: Office Open XML document, Open XML document, and/or Microsoft Word® document. All refer to the Microsoft Word® 2007/2010 default document format (*.docx), as further described and defined by the Office Open XML specification standardized by Ecma (i.e., ECMA-376), and subsequently described and defined by International Organization for Standardization (ISO) and International Electrotechnical Commission (IEC) (i.e., ISO/IEC standard 29500).

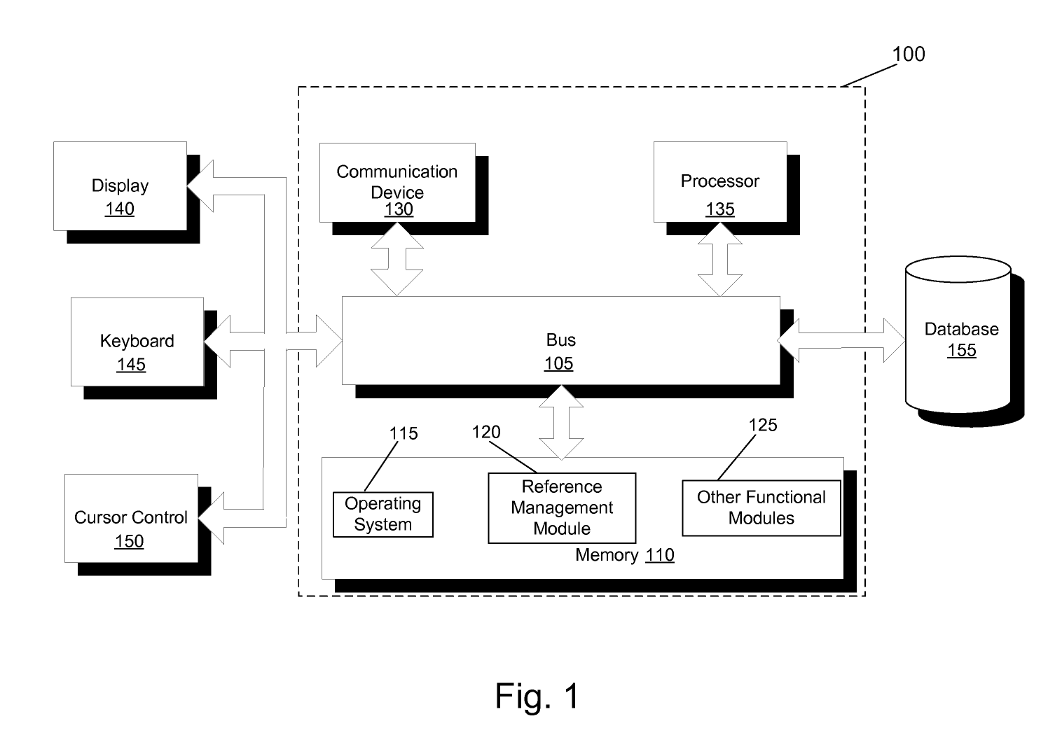

FIG. 1 illustrates a block diagram of an apparatus 100, according to an embodiment of the invention. Apparatus 100 includes a bus 105 or other communications mechanism for communicating information between components of apparatus 100. Apparatus 100 also includes a processor 135, operatively coupled to bus 105, for processing information and executing instructions or operations. Processor 135 may be any type of general or specific purpose processor. Apparatus 100 further includes a memory 110 for storing information and instructions to be executed by processor 135. Memory 110 can be comprised of any combination of random access memory (RAM), read only memory (ROM), static storage such as a magnetic or optical disk, or any other type of machine or computer-readable medium. Apparatus 100 further includes a communication device 130, such as a network interface card or other communications interface, to provide access to a network. As a result, a user may interface with apparatus 100 directly, or remotely through a network or any other method. In addition, apparatus 100 may interface with any resources through a network using communication device 130.

A computer-readable medium may be any available medium that can be accessed by processor 135. A computer-readable medium may include both a volatile and nonvolatile medium, a removable and non-removable medium, and a storage medium. A storage medium may include RAM, flash memory, ROM, erasable programmable read-only memory (EPROM), electrically erasable programmable read-only memory (EEPROM), registers, hard disk, a removable disk, a compact disc read-only memory (CD-ROM), or any other form of storage medium known in the art.

Processor 135 can also be operatively coupled via bus 105 to a display 140, such as a Liquid Crystal Display (LCD). Display 140 can display information to the user. A keyboard 145 and a cursor control device 150, such as a computer mouse, can also be operatively coupled to bus 105 to enable the user to interface with apparatus 100.

According to one embodiment, memory 110 can store software modules (i.e., modules) that may provide functionality when executed by processor 135. The modules can include an operating system 115, a reference management module 120, as well as other functional modules 125. Operating system 115 can provide an operating system functionality for apparatus 100. Reference management module 120 can provide functionality for managing one or more references in a collection of documents, as is described in more detail below. In certain embodiments, reference management module 120 can comprise a plurality of modules that each provide specific individual functionality for managing one or more references in a collection of documents. Apparatus 100 can also be part of a larger system. Thus, apparatus 100 can include one or more additional functional modules 125 to include the additional functionality. In certain embodiments, additional functional modules 125 can include a word processor module that can provide functionality for word processing, such as opening, editing, and saving one or more documents. In some of these embodiments, the word processor module can be a Microsoft Word® module.

Processor 135 can also be operatively coupled via bus 105 to a database 155. Database 155 can store data in an integrated collection of logically-related records or files. Database 155 can be an operational database, an analytical database, a data warehouse, a distributed database, an end-user database, an external database, a navigational database, an in-memory database, a document-oriented database, a real-time database, a relational database, an object-oriented database, or any other database known in the art.

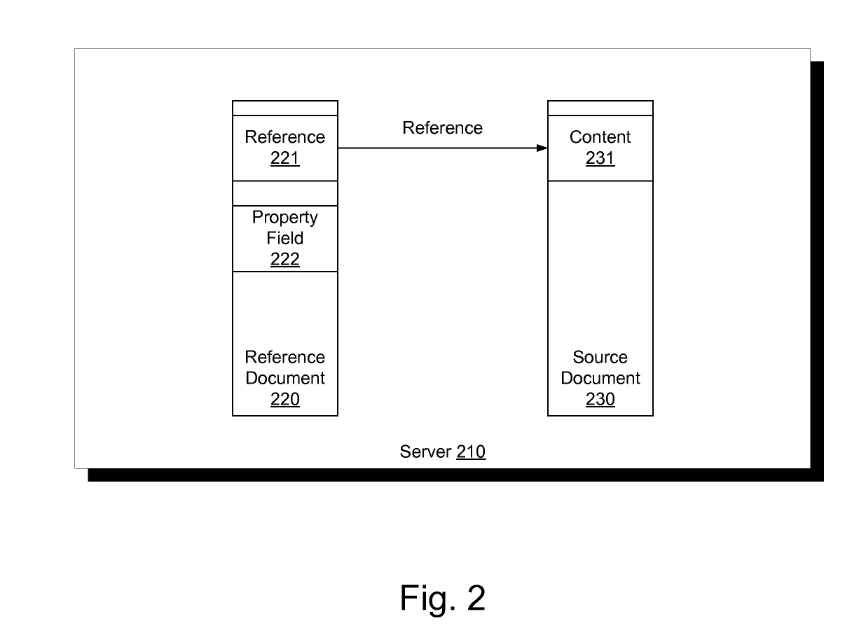

FIG. 2 illustrates a process of creating one or more property fields for a referencing document, where the referencing document includes a reference to a referenced document, according to an embodiment of the invention. In certain embodiments, the process can be implemented by reference management module 120 of FIG. 1, when executed by processor 135 of FIG. 1. According to the embodiment, the process involves a server 210. Server 210 can be any type of server that is known to one of ordinary skill in the relevant art, such as an application server, or a web server. In certain embodiments, server 210 is a content management server. A content management server is a server that provides functionality for publishing, editing, and modifying content, such as one or more documents. Such functionality can include: allowing multiple users to share and contribute to stored content; controlling access to content based on a role associated with a user; facilitating storage and retrieval of content; controlling content validity and compliance; reducing duplicate inputs of content; defining what type of content can be stored within the content management server (e.g., what type of documents can be stored), and producing one or more reports based on content stored. In certain embodiments, a content management server can also include the following functionality: (a) event-firing functionality and an API for implementing event handling functionality; (b) functionality for defining property fields for documents, as is described below in greater detail; (c) a crawling index that can crawl, or automatically browse, property fields in an orderly fashion; (d) a search engine capable of searching crawled property fields; and (e) an API for the search engine, allowing programmatic queries against the search index. In certain embodiments, server 210 is a Microsoft SharePoint® server.

In certain embodiments, reference document 220 and source document 230 are stored within server 210. Reference document 220 and source document 230 are each capable of storing content. In certain embodiments, reference document 220 and source document 230 are XML documents (such as Open Office XML documents). In certain embodiments, reference document 220 and source document 230 are Microsoft Word® documents. In alternate embodiments, additional documents (not shown in FIG. 2) can be stored within server 210.

According to the embodiment, as illustrated in FIG. 2, reference document 220 can include reference 221. Reference 221 is a reference to content 231 contained within source document 230, where content 231 can include any type of content, such as, text, a paragraph, a collection of paragraphs, a table, or a chart. In certain embodiments, reference 221 is a hyperlink. In some of these embodiments, the hyperlink includes one or more action parameters. Such hyperlinks that include one or more action parameters are described in greater detail in U.S. Pat. No. ______/______,______, “CONTENT REFERENCE IN EXTENSIBLE MARKUP LANGUAGE DOCUMENTS,” the contents of which are herein incorporated by reference. In alternate embodiments, reference 221 can be a hyperlink to a uniform resource locator (URL) outside server 210, a hyperlink to a media file either contained inside server 210 or outside server 210, or some other type of hyperlink.

According to the embodiment, as also illustrated in FIG. 2, reference document 220 can also include property field 222. Property field 222 is a field that is designed to store reference information associated with an outbound reference of the document in question. In the illustrated embodiment, property field 222 stores reference information associated with reference 221 of reference document 220. In certain embodiments, the reference information includes information pertaining to a location of content that the document in question references. For example, in the illustrated embodiment, property field 222 includes reference information, where the reference information includes a value associated with a location of source document 230. In certain embodiments, the value associated with a location of source document 230 can be a URL.

The following is an example of a property field:

### Property Field Name:

DxLinks

### Property Field Content:

http://www.intranet.com/repository/document1.docx; http://www.intranet.com/repository/document2.docx; http://www.intranet.com/repository/document3.docx

In the above example, the property field includes a name (i.e., “D×Links”) of the property field, and includes content, where the content includes reference information pertaining to locations of the documents that the current document references (i.e., “http://www.intranet.com/repository/document1.docx,” “http://www.intranet.com/repository/document2.docx,” “http://www.intranet.com/repository/document3.docx”).

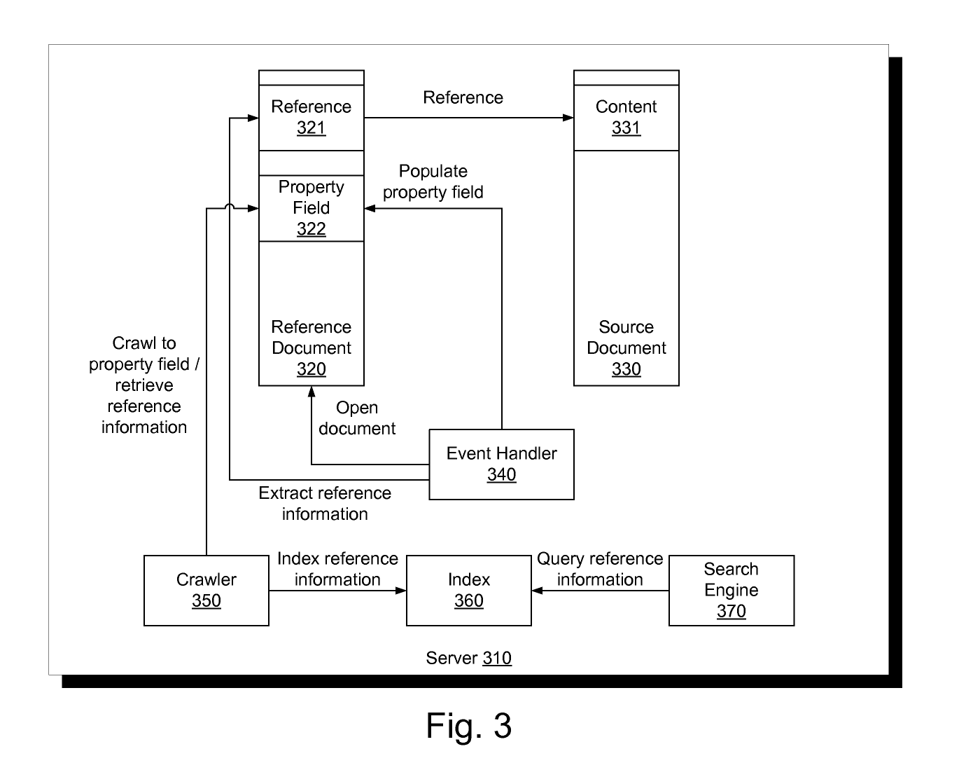

FIG. 3 illustrates a process of creating one or more property fields for a document, where the document is created or updated, according to an embodiment of the invention. In certain embodiments, the process can be implemented by reference management module 120 of FIG. 1, when executed by processor 135 of FIG. 1. According to the embodiment, the process involves a server 310. Similar to server 210 of FIG. 2, server 310 can be any type of server that is known to one of ordinary skill in the relevant art, such as an application server, or a web server. In certain embodiments, server 310 is a content management server.

In certain embodiments, reference document 320 and source document 330 are stored within server 310. Similar to reference document 220 and source document 230 of FIG. 2, reference document 320 and source document 330 are each capable of storing content. In certain embodiments, reference document 320 and source document 330 are XML documents (such as Open Office XML documents). In certain embodiments, reference document 320 and source document 330 are Microsoft Word® documents. In alternate embodiments, additional documents (not shown in FIG. 3) can be stored within server 310.

According to the embodiment, as previously described in relation to FIG. 2, and illustrated in FIG. 3, reference document 320 can include reference 321. Reference 321 is a reference to content 331 contained within source document 330, where content 331 can include any type of content, such as, text, a paragraph, a collection of paragraphs, a table, or a chart. As also previously described in relation to FIG. 2, and as also illustrated in FIG. 3, reference document 320 can also include property field 322.

Also in certain embodiments, server 310 includes an event handler 340, a crawler 350, an index 360, and a search engine 370. As one of ordinary skill in the art would readily appreciate, event handler 340 is a module that can receive one or more events raised (or created) by another module, and perform functionality based on the one or more events. As one of ordinary skill in the art would also appreciate, crawler 350 is a module that can browse a collection of documents (such as reference document 320 and source document 330) and identify one or more property fields. Index 360, as is described below in greater detail, is an index of one or more property fields. Search engine 370, as understood by one of ordinary skill in the art, is a module that can perform one or more queries on a data source, such as index 360, and return one or more results based on the one or more queries.

According to the embodiment, an operation can be performed on reference document 320. For example, reference document 320 can be initially created and stored within server 310. As another example, reference document 320 can be updated, and an updated version of reference document 320 can be stored within server 310. The operation that is performed on reference document 320 can trigger event hander 340, where event handler 340 can call a processor, such as processor 135 of FIG. 1 (not shown in FIG. 3). The processor can open reference document 320 and can extract reference information contained within reference document 320. More specifically, the processor can identify all references contained within reference document 320, determine all reference information associated with all references, and extract the reference information. In the illustrated embodiment, the processor can identify reference 321, determine reference information associated with reference 321, and extract the reference information associated with reference 321. In certain embodiments, the reference information associated with reference 321 can include a value associated with a location of source document 330. The processor can then populate one or more property fields contained within reference document 320 with the extracted reference information. In the illustrated embodiment, the processor can populate property field 322 with the extracted reference information associated with reference 321.

The following in an example of a portion of an Open XML document that can be opened and analyzed by the processor when called by event handler 340 (i.e., document.xml.rels file found in the /word/_rels part of an Open XML OPC document package):

```
<Relationships xmlns=“http://schemas.openxmlformats.org/package/2006/relationships”>
  <Relationship  Id=“rId3” Type=“http://schemas.openxmlformats.org/officeDocument/2006/relationships/settings”
Target=“settings.xml”/>
  <Relationship  Id=“rId7” Type=“http://schemas.openxmlformats.org/officeDocument/2006/relationships/theme”
Target=“theme/theme1.xml”/>
  <Relationship  Id=“rId2” Type=“http://schemas.microsoft.com/office/2007/relationships/stylesWithEffects”
Target=“stylesWithEffects.xml”/>
  <Relationship  Id=“rId1” Type=“http://schemas.openxmlformats.org/officeDocument/2006/relationships/styles”
Target=“styles.xml”/>
  <Relationship  Id=“rId6” Type=“http://schemas.openxmlformats.org/officeDocument/2006/relationships/fontTable”
Target=“fontTable.xml”/>
  <Relationship  Id=“rId5” Type=“http://schemas.openxmlformats.org/officeDocument/2006/relationships/hyperlink”
Target=“http://www.intra.com/doc1.docx” TargetMode=“External”/>
  <Relationship  Id=“rId4” Type=“http://schemas.openxmlformats.org/officeDocument/2006/relationships/webSettings”
Target=“webSettings.xml”/>
</Relationships>
```

In the above example, the relationship with Id=“rId5” contains a reference (e.g., link) to doc1.docx that can be analyzed by the processor, and the reference information associated with the reference (i.e., link) can be extracted by the processor.

According to the embodiment, crawler 350 can crawl to property field 322 and retrieve reference information associated with reference 321. Crawler 350 can then index the retrieved reference information associated with reference 321. This can be done by either creating or updating index 360. Subsequently, search engine 370 can create one or more queries of the reference information. Such queries can include, for example: (1) identify all documents containing non-resolvable internal references (e.g., links) in a collection of Open XML documents in a content management server; (2) identify all documents with a reference (e.g., link) to a specific Microsoft Word® document; and (3) identify (and modify) all documents with references (e.g., links) to URL X, and modify the references (links) to reference URL Y.

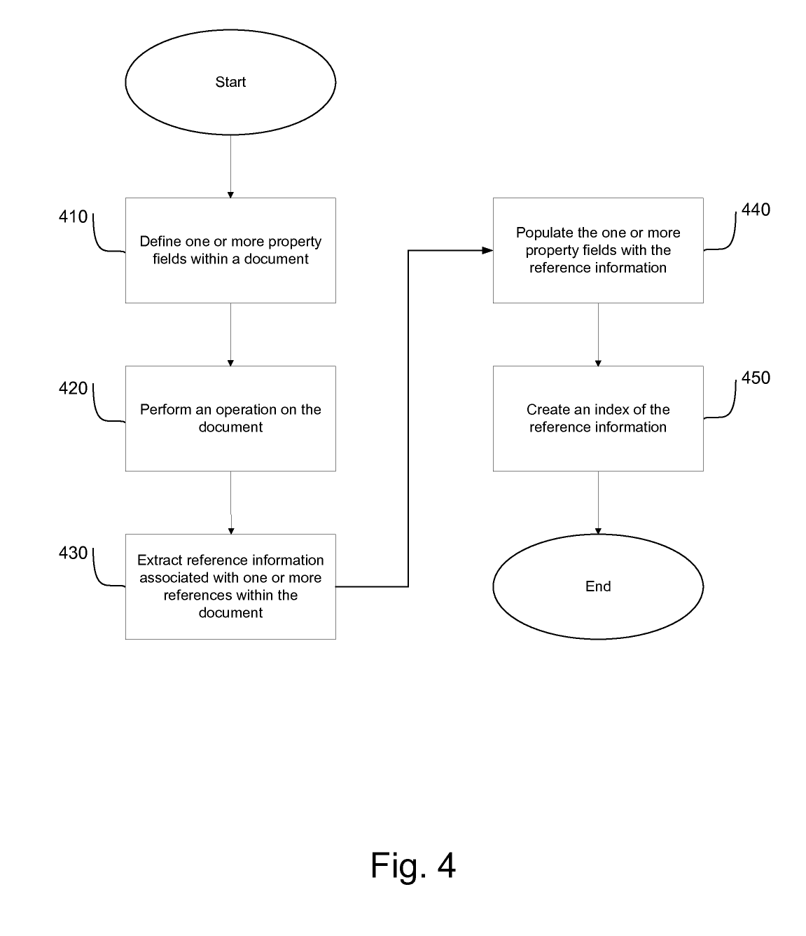

FIG. 4 illustrates a method according to an embodiment of the invention. The steps of a method or algorithm described in connection with the embodiments disclosed herein may be embodied directly in hardware, in a computer program executed by a processor, or in a combination of the two. A computer program may be embodied on a computer-readable medium, such as a storage medium. For example, a computer program may reside in RAM, flash memory, ROM, EPROM, EEPROM, registers, hard disk, a removable disk, a CD-ROM, or any other form of storage medium known in the art. An exemplary storage medium may be coupled to the processor such that the processor can read information from, and write information to, the storage medium. In the alternative, the storage medium may be integral to the processor. The processor and the storage medium may reside in an application specific integrated circuit (ASIC). In the alternative, the processor and the storage medium may reside as discrete components. Furthermore, a computer-readable medium may be any type of tangible medium.

The flow begins and proceeds to step 410. At step 410, one or more property fields are defined within a document of a collection of one or more documents. The one or more property fields can store reference information. The collection of one or more documents can be stored on a content management server.

In certain embodiments, the content management server is a Microsoft Sharepoint® server. In certain embodiments, the document is an Open XML document. The flow then proceeds to step 420.

At step 420, an operation is performed on the document. In certain embodiments, the operation is a create operation. In other embodiments, the operation is an update operation. The flow then proceeds to step 430.

At step 430, reference information associated with one or more references within the document is extracted. The one or more references can reference content located outside of the document. In certain embodiments, each reference of the one or more references is a hyperlink. In certain embodiments, the content is stored within another document of the collection of one or more documents. In other embodiments, the content is stored outside of the collection of one or more documents. In certain embodiments, the reference information includes a value associated with a location of the content located outside of the document. In some of those embodiments, the value is a uniform resource locator. The flow then proceeds to step 440.

At step 440, one or more property fields are populated with the reference information associated with the one or more references within the document. The flow then proceeds to step 450.

At step 450, an index of the reference information populated within the one or more property fields is created. The index is associated with the collection of one or more documents. In some embodiments, a query of the reference information populated within the one or more property fields can be created. The query can be based on the index. The flow then ends.

Thus, according to certain embodiments, management of reference information of a collection of one or more documents can be provided, where the management involves a processor that works as previously described. The processor does not create any requirements on the authoring/editing tool used to create and/or update the documents. Furthermore, the processor can make optimal use of the search engine of the content management server and search index. This can allow for extremely fast and highly optimized queries (as fast as 0.01 seconds). Thus, very powerful and flexible solutions can be built on the basis of the previously described processor.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims

We claim:

1. A method, comprising:
defining one or more property fields within a document of a collection of one or more documents, wherein the one or more property fields store reference information;
performing an operation on the document;
extracting reference information associated with one or more references within the document, wherein the one or more references reference content located outside of the document;
populating the one or more property fields with the reference information associated with the one or more references within the document; and
creating an index of the reference information populated within the one or more property fields, wherein the index is associated with the collection of one or more documents.

2. The method of claim 1, further comprising creating a query of the reference information populated within the one or more property fields.

3. The method of claim 1, wherein the collection of one or more documents is stored on a content management server.

4. The method of claim 3, wherein the content manager server comprises a Microsoft Sharepoint® server.

5. The method of claim 1, wherein the document comprises an Open extensible markup language (XML) document.

6. The method of claim 1, wherein each reference of the one or more references comprises a hyperlink.

7. The method of claim 1, wherein the content is stored within another document of the collection of one or more documents.

8. The method of claim 1, wherein the content is stored outside of the collection of one or more documents.

9. The method of claim 1, wherein the reference information comprises a value associated with a location of the content located outside of the document.

10. The method of claim 9, wherein the value comprises a uniform resource locator.

11. The method of claim 1, wherein the operation comprises a create operation.

12. The method of claim 1, wherein the operation comprises an update operation.

13. An apparatus, comprising:
a memory configured to store one or more modules;
a processor configured to execute one or more modules stored within the memory;
a property field definition module configured to define one or more property fields within a document of a collection of one or more documents, wherein the one or more property fields store reference information;
an operation module configured to perform an operation on the document;
a reference information extraction module configured to extract reference information associated with one or more references within the document, wherein the one or more references reference content located outside of the document;
a property field population module configured to populate the one or more property fields with the reference information associated with the one or more references within the document; and
a reference information index module configured to create an index of the reference information populated within the one or more property fields, wherein the index is associated with the collection of one or more documents.

14. The apparatus of claim 13, further comprising a reference information query module configured to create a query of the reference information populated within the one or more property fields.

15. The apparatus of claim 13, wherein the apparatus comprises a content management server.

16. The apparatus of claim 15, wherein the content management server comprises a Microsoft Sharepoint® server.

17. The apparatus of claim 13, wherein the document comprises an Open extensible markup language (XML) document.

18. The apparatus of claim 13, wherein each reference of the one or more references comprises a hyperlink.

19. The apparatus of claim 13, wherein the content is stored within another document of the collection of one or more documents.

20. The apparatus of claim 13, wherein the content is stored outside of the collection of one or more documents.

21. The apparatus of claim 13, wherein the reference information comprises a value associated with a location of the content located outside of the document.

22. The apparatus of claim 13, wherein the value comprises a uniform resource locator.

23. A non-transitory computer-readable medium, comprising a computer program embodied therein, configured to control a processor to implement a method, the method comprising:
defining one or more property fields within a document of a collection of one or more documents, wherein the one or more property fields store reference information;
performing an operation on the document;
extracting reference information associated with one or more references within the document, wherein the one or more references reference content located outside of the document;
populating the one or more property fields with the reference information associated with the one or more references within the document; and
creating an index of the reference information populated within the one or more property fields, wherein the index is associated with the collection of one or more documents.

24. The non-transitory computer-readable medium of claim 23, the method further comprising creating a query of the reference information populated within the one or more property fields.

25. The non-transitory computer-readable medium of claim 23, wherein each reference of the one or more references comprises a hyperlink.

26. The non-transitory computer-readable medium of claim 23, wherein the content is stored within another document of the collection of one or more documents.

27. The non-transitory computer-readable medium of claim 23, wherein the content is stored outside of the collection of one or more documents.

28. The non-transitory computer-readable medium of claim 23, wherein the reference information comprises a value associated with a location of the content located outside of the document.
